(19) United States
(12) Patent Application Publication
(10) Pub. No.: US 2011/0000373 A1
(43) Pub. Date: Jan. 6, 2011

(54) Removable vertical foam media insert system for pollutant stream remediation reactors

(76) Inventors: Martin Crawford, Stateline, NV (US); Jeff Jones, Belton, TX (US)

Correspondence Address: William S. Bernheim, 255 N. Lincoln St., Dixon, CA, 95620, US

(21) Appl. No.: 12/807,444

(22) Filed: Sep. 7, 2010

Related U.S. Application Data
(63) Continuation-in-part of application No. 12/804,195, filed on Jul. 16, 2010, now abandoned.
Application No. 12/804,195 is a continuation of application No. 11/800,517, filed on May 7, 2007, now Pat. No. 7,785,402.

(51) Int. Cl. B01D 46/00; B01D 39/14

(52) U.S. Cl. 95/274; 55/515

(57) ABSTRACT

A support framework for containing a structurally integral, porous remediation media, such as foam or reticulated foam that is used to remediate corrosive vaporous pollutants in a contaminated inlet stream. The support framework is situated within a plenum and comprises a pair of open-lattice weave frameworks made from corrosion resistant fiberglass reinforced plastic “FRP”. The frameworks are of differing diameters and are concentrically aligned such that a media containment section is formed within the open space formed between the inside wall of the outer framework and the outside wall of the inner framework. The open-lattice weave design allows a greater radial flow through the media per unit of time, doing so with less pressure drop and using less energy than the prior art. The use of FRP to form the framework walls allows creation of large units that are suitable for use in municipal and industrial settings, which was not possible previously.

This application is a Continuation In Part (C.I.P.) of application Ser. No. 12/804,195 that was filed on Jul. 16, 2010, which was a Continuation of application Ser. No. 11/800,517 that was filed on May 7, 2007.

### BACKGROUND OF THE INVENTION

1. Field of Invention

The invention relates to an apparatus and process used for removing pollutants from a contaminated air or water stream “Stream” in which a media support wall “framework” is designed to compensate for the problems commonly associated with media compaction in vertically standing radial flow contaminated Stream purification systems “reactors”; the framework and a media being supported are integral but not unitary.

More particularly it relates to the use of open weave fiberglass reinforced plastic “FRP” to create a media containment framework within a plenum that contains a remediation media which media facilitates interactions which capture pollutants from a Stream being moved horizontally and radially through the media either inwardly or outwardly.

2. Description of the Relevant Prior Art

Vaporous pollutants, which are frequently toxic or corrosive or both, are created in a multiplicity of municipal, commercial and agricultural processes and become part of output Streams. Treatment of these output Streams to strip out the pollutants is important to human health, to prevent damage to equipment, to protect the environment and to provide odor control.

Typical treatment of Streams is to pass the Stream through a reactive media in a containment structure within a plenum which serves as a reactor. Issues include plenum size, choice of material and energy consumption. In instances where the Stream contains corrosive gases, the materials used to form the containment structure are chosen to be as non-reactive as practical. This need has traditionally placed a limitation upon the size of media containment structures. Used alone as inert structural materials, plastics do not have the structural strength for creating large structures. Metals have the strength but corrode too easily.

Over time, two differing reactor designs have emerged. The earlier reactors used vertical flow of the Stream under pressure or vacuum, thus requiring a considerable consumption of energy in their operation.

On the other hand, radial flow reactors work at ambient or just above ambient pressures, requiring no compressors or vacuum units or expensive seals for their operation and presenting less potential for escape of untreated materials into the environment.

In general, radial-flow reactors consist of a containment vessel, a plenum, within which is located a series of baffles that separate the incoming polluted Stream from the exiting purified Stream. The space between the baffles holds and supports the remediation media. Commonly, the baffles consist of a pair of cylindrically shaped elements, one having a smaller diameter than the other and being concentrically located within the former. These cylinder walls have pore spaces through which the Stream passes. In an inward flow reactor, the Stream moves from an inlet manifold through the outer baffle into the remediation medium, and then through the inner baffle and into an exit manifold. Or the reactor can be designed to have a reversed flow direction described as an outward flow reactor.

Past radial flow reactor designs suffered from some problems of their own. One of the main problems being that the structural weakness of non-reactive media containment materials prevented the creation of units large enough to efficiently handle large volumes of pollutants. Increasing the bulk of the solid portion of the containment cylinders to make the walls stronger reduced the amount of open Stream flow space within the cylinder walls, thus decreasing the efficiency of and increasing the cost of operating the unit.

### STATEMENT OF THE OBJECTIVES

Accordingly, it is an objective of this invention to provide a corrosion resistant media support system for use in a radial flow reactor, said support system having the structural strength allowing for its use in large commercial and municipal reactors, yet also having a flexibility of design allowing for a use in small sized reactors, and at the same time providing a media containment support wall with a lower solid to through space ratio that allows for a remediation of a greater volume of Stream per unit of time relative to other comparably sized units and doing so with a low pressure drop from an inlet side to an outlet side of the media containment structure, thus providing a simplification of installation and a conservation of energy.

Another object of the invention is to provide a media containment structure that is equally suitable for use with a variety of media, including porous granular substrate media such as activated carbon, or, non-granular media such as foam and reticulated foam; foam media, being essentially integral within themselves in that they have their separate, internal pore spaces that do the filtering of the contaminated stream, therefore need less framework support wall than do media such as activated carbon media; thus, for supporting foam media, the framework wall pore spaces can be maximized to provide a maximal flow of the Stream into the media itself.

Another object of this invention is to provide a containment structure design that allows a creation of supports that can be retrofitted into existing reactors.

Other objectives, advantages and novel features of the invention will become apparent to those skilled in the art upon examination of the invention and the accompanying drawings.

### SUMMARY OF THE INVENTION

The invention involves the creation of a pair of corrosion resistant fiberglass-reinforced plastic (“FRP”) media support wall frameworks of differing diameters that have been extruded in a diamond shape lattice weave wall pattern, each with approximately a 68.percent through space ratio. The walls of each of which frameworks comprise a series of overlaid, fused, woven bands of FRP material.

The frameworks are situated in a concentric manner, one within the other within a vertically standing plenum, an internal space between said concentrically aligned support walls comprises a media bed, said framework arrangement being designed to hold a media capable of remediating toxic, corrosive, or non-corrosive vapors that are carried to it in a Stream that moves through the purification system in a radial flow direction; said Stream moving at or slightly above ambient air pressure, and passing through the reactor with a minimal pressure drop between an in let side and an outlet side of the reactor.

Dwyer (U.S. Pat. No. 3,162,516) discloses an exhaust filtering process wherein pressurized gas is received into an inlet of a plenum. The gas then flows radially through an essentially granular media that is contained between stainless steel mesh support cylinders that have a diamond shape basket weave wall arrangement. The diamond shape weave presents with pores that allow passage of the gas and is of a design such that the open spaces between the lattice wall elements are small enough to retain the enclosed media particles.

This application differs from Dwyer in that the present invention claims a preferred through space. Dwyer does not teach or claim a preferred through space. Further, having a diamond shaped basket weave arrangement of the filter casement wall is critical in the present invention, and, Dwyer does not teach such.

The incident application differentiates even further from Dwyer in that applicants teach a design and process for using a basket weave wall arrangement for media that are essentially integral within themselves; media having an integral form within which is found a series of internal pore spaces that do the filtering of the contaminated stream; for such a media, the framework wall pore spaces can be maximized to provide support for the filtering media in position and to allow a maximal flow of the Stream into the media itself.

And, opposed to Dwyer, the instant application operates at near ambient air pressures and with a minimal pressure drop across the media between the inlet and the outlet sides of the plenum, thus preventing the need for expensive seals and other problems associated with high pressure systems.

Like Dwyer, Sewell, Sr. (2005/0126139A1) discloses an exhaust filtering process wherein pressurized gas is received into an inlet of a plenum. The gas then flows radially through an essentially granular media that is contained between stainless steel mesh support cylinders that have a diamond shape basket weave wall arrangement. The diamond shape weave present pores that allow passage of the gas is of a design such that the open spaces between the lattice wall elements are small enough to retain the enclosed media particles. Sewell also teaches that the support cylinders can be made of a polymer-fiberglass material. Whether stainless steel or polymer fiberglass in nature, Sewell, Sr. did not recognize, teach or claim a preferred through space for a specific media

The preferred through space taught by the current invention is one of the major distinctions vs. Sewell. Part of the motivation for use of the FRP wall sandwich was to provide for a low pressure alternative to prior art models which required high pressure to force the air through the reactor. The prior art therefore involved use of expensive seals and pressurizing equipment, and increased risk of contaminated materials breaching into the ambient environment. The maximal through space of their containment walls was approximately 50% as opposed to the 65% to 75% through space achievable with the current invention.

Sewell's design appears to be able to operate with an even greater through space. However, the through space component of the design of the current invention is not a stand alone factor. The full equation includes the following: 1. maximal through space; in concert with 2. adequate structural strength to allow a free standing support capable of containing a large weight of media material without distortion, and 3. operation without the need for a high pressure air stream and the special fittings, gaskets and the increased costs and maintenance associated with handling high pressure air streams.

Lightweight mesh screen support walls such as described by Sewell do not meet the strength requirements needed for the present application. Prior art in the field used stronger wall materials and design (scalloped and punched openings) as described by Sewell; however, they could not achieve over a 50% through space limit using such means.

It was the use of the FRP sandwich wall woven in a diamond shaped basket weave configuration having a preferred through space that provided the combined elements of maximal through space, free standing structural strength and operational ability at slightly above ambient air pressure.

In Sewell, the only demand of the support wall is that the wall contain pores of a size small enough to contain the filtering material and load bearing strength is not an issue.

In the present invention specifically for a use with a media that is essentially integral within itself; in order to maximize the efficiency of the filtering system, the critical wall feature is to maximize a series of open spaces in a support wall to the greatest extent possible, thereby allowing a maximal flow of an inflowing Stream at near ambient air pressures and doing so with a minimal pressure drop across the media between an inlet side and an outlet side of a plenum, thus preventing the need for expensive seals and other problems associated with high pressure systems such as Sewell, Sr.'s.

### BRIEF DESCRIPTION OF THE DRAWINGS

Further objectives and advantages of the invention will be apparent from the following detailed description when taken in conjunction with the accompanying drawings illustrating a preferred embodiment of the invention. The drawings are:

FIG. 1A: Presents a cross sectional view according to the invention looking down onto the top of a cylindrical media support framework.

FIG. 1B: Presents a diagrammatical cross sectional view according to the invention looking down onto the top of an octahedral multifaceted tubular media support framework.

FIG. 1C: presents a diagrammatic representation of a section of a Framework—showing the solid and through space components arranged in a diamond shaped basket weave configuration (not to scale).

FIG. 2. Presents a perspective view as a vertical cross section at the vertical axis center of a radial-flow air remediation system plenum.

FIG. 3A. Presents a diagrammatic lateral view of the inter-connected attachment of the removable split-cover top plate sections of the plenum's top cover as well as the relationship of the removable split-cover top plate section to the side walls of the base section of the plenum.

FIG. 3B. Presents a diagrammatic lateral view of an alternative embodiment of the plenum, showing the lower section of the base of the plenum and its relationship to a pair of integral floor sections of the lateral and central frameworks

### DETAILED DESCRIPTION OF A PREFERRED EMBODIMENT

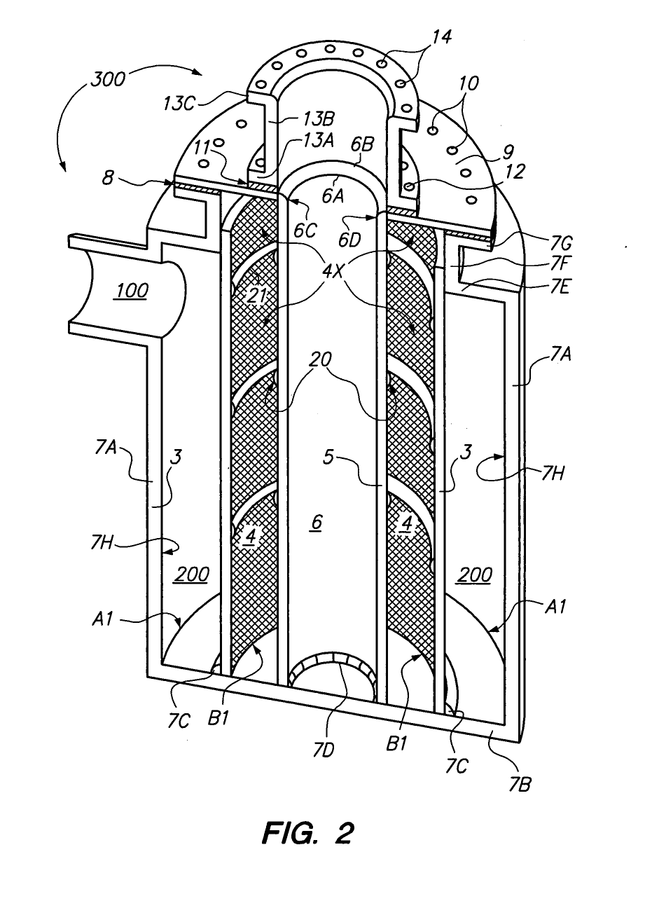

The invention involves the creation of a device, a media containment system comprising in part a pair of media support frameworks 3/5 FIG. 2; said pair of frameworks comprising a pair of frameworks of a differing diameter and being situated with a framework of a lesser diameter, a smaller, central framework 5 FIG. 2 standing within a framework of a greater diameter, a larger, lateral framework 3 FIG. 2; and, said frameworks being in a coaxial alignment between themselves and relative to a side wall 7A FIG. 2 of a vertically standing radial flow remediation plenum 300 FIG. 2; said plenum serving as a purification reactor providing for a remediation/purification of a one or more toxic contaminants from a contaminated Stream; said toxic contaminants being selected from the group consisting of corrosive and non-corrosive vapors.

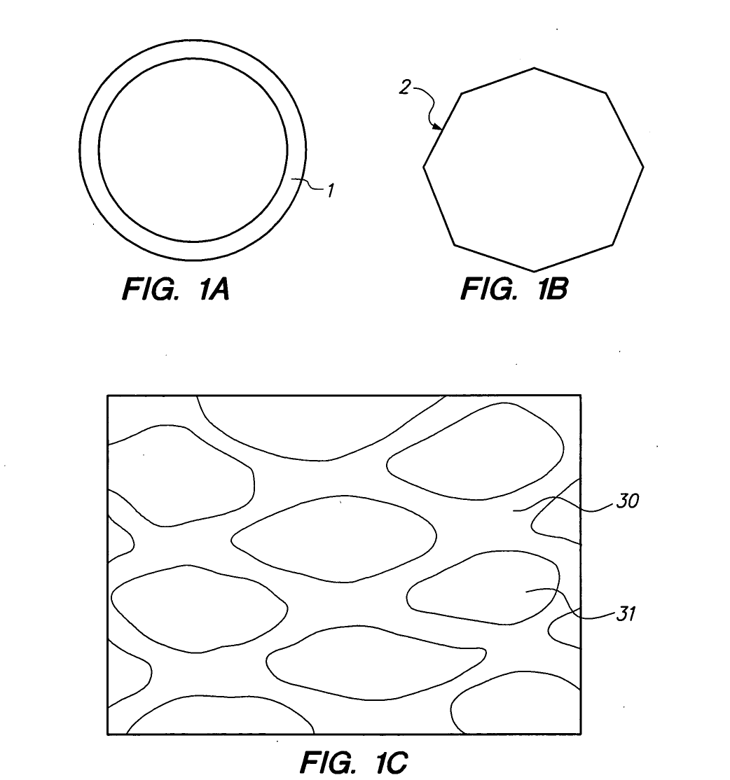

In accord with an object of a creation of frameworks that can be retrofitted into existing vertically standing radial flow remediation plenums, which said plenums may be of differing tubular configurations, each of any said pair of frameworks may have a configuration selected from the group consisting of cylindrical 1 FIG. 1A and multifaceted tubular 2 FIG. 1B structures;

A solid component of said central and said lateral frameworks 30 FIG. 1C, is seen to comprise a basket weave diamond shape lattice pattern within which is enclosed a series of openings “through spaces” 31 FIG. 1C; said basket weave wall framework's said solid components comprising a fiberglass reinforced plastic “FRP” material, said FRP solid wall component comprising a sandwich of a set of overlapping layers that are fused together into a singular element.

A solid component of the framework wall elements comprising up to an approximate 32.percent portion of a total wall surface area of said frameworks, thus a total wall surface area presents with an approximately 68.percent through space; affording thus a maximal Stream flow opening while creating an exceptional structural strength of the framework walls.

When viewing a perspective view as a vertical cross section at a longitudinal center of said air remediation plenum 300 FIG. 2; a media containment section 4 FIG. 2 is seen. Said FRP wall of said media containment section, by providing said approximately 68.percent through space, being of a design specifically selected to contain and support a structurally integral, porous remediation media 4X FIG. 2, said structurally integral media, commonly comprising a foam media or a reticulated foam media.

Said media containment section being bounded externally by an internal aspect of said lateral framework wall 3 and bound centrally by a lateral aspect of said central framework wall 5; a bottom boundary of said media containment section being provided by a floor 7B FIG. 2 of said plenum and a top boundary comprising a section of a split cover top plate 9 FIG. 2 of said plenum; said boundaries serving as a means of a prevention of an escape of contaminated Stream material into the environment.

Said media capable of providing a remediation of said toxic contaminants that are carried to it in said Stream, which said Stream is flowing at a ambient or just above ambient air pressure, and that moves through the purification reactor system in a radial flow direction.

Said support walls 3 & 5 FIG. 2 are in an alignment coaxially with said vertically standing external wall of said plenum 7a, and provide for a uniform thickness of remediation medium in a radial direction between an inlet-manifold side 200 and an outlet-manifold side 6 FIG. 2 of said plenum over an entire length of said media containment section 4.

By presenting a perspective view as a vertical cross section at the vertical axis center of said radial-flow air remediation plenum 300 FIG. 2 as a preferred embodiment, a knowledgeable person can learn one method of an alignment, support and stabilization of said media support walls that are the foundation of this invention; said alignment, support and stabilization serving as a means of a prevention of an escape of contaminated Stream materials from said plenum.

This example is not intended to represent nor should it be taken to be the sole manner of appropriately aligning and supporting said frameworks, rather, it is presented to educate people familiar with the art as to a method of fabricating a plenum such that there is an ease of introduction and removal of said frameworks into said plenum as needed, and such that a control of said Stream pathway throughout said plenum presents a minimal possibility of an escape of contaminated Stream materials into the environment while providing for a maximal flow of said Stream from a Stream inlet 100 FIG. 2 side to said outlet manifold side of said plenum with a minimal pressure drop between said inlet and said outlet sides of said radial flow purification reactor.

Said plenum 300 FIG. 2 that contains said frameworks 3 & 5 further partially comprises a base section 7ABCDEFG, and a split-cover top plate 9 that is removable.

A contaminated Stream enters said plenum through said air inlet 100 FIG. 2, and enters said inlet manifold 200, the lateral wall of which said inlet manifold 200 is formed by an inner aspect 7H FIG. 2 of a side wall 7A of said plenum. Said contaminated Stream then flows horizontally through said lateral support framework wall 3 FIG. 2, then continues radially through said media containment section 4, next passing through said internal most support framework wall 5, and into said outlet manifold 6 after which it exits as a remediated, purified stream.

In the present embodiment, wherein the frameworks are not removed during a process of media replacement, a base end of said external framework and a base end of said internal framework are not conjoined to a floor 7B FIG. 2 of said plenum nor are they in a conjoinment between themselves.

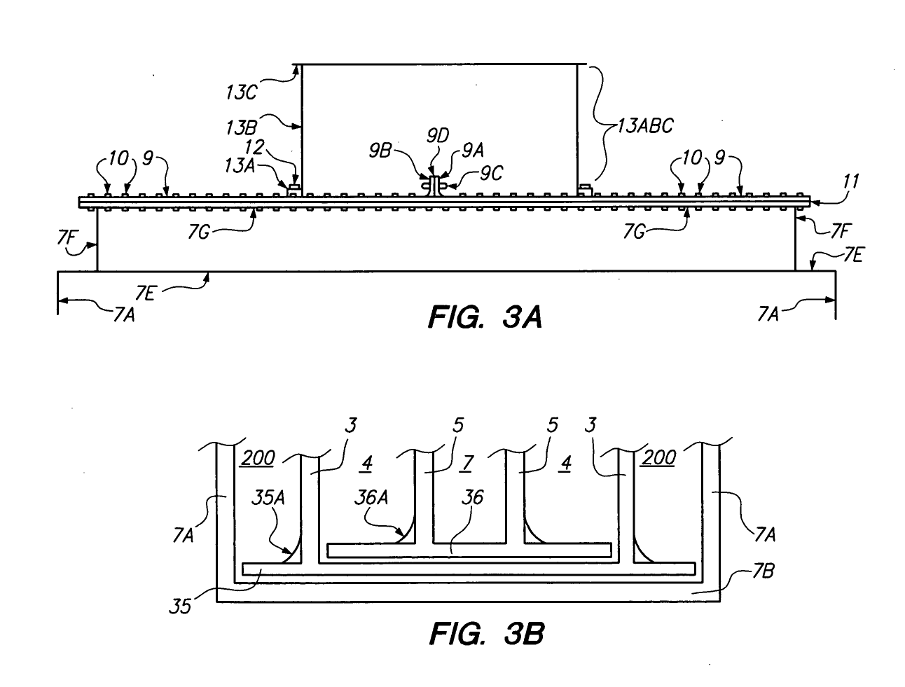

However, for a use within a radial flow remediation plenum designed to allow a removal of said frameworks as a unit for purposes of a replacement of said media, a base end of each of said FRP frameworks is in a conjoinment by a fusion to an integral floor section 35 and 36 FIG. 3B, said integral floor sections of said lateral and central frameworks being separate from each other and separate from said floor of said plenum 7B FIG. 3B and allowing of a formation of a basket shape media bed 4 FIG. 3B comprising a set of portions of said framework walls and integral floors 3,5,35,36 FIG. 3B; forming thus a bottom seal boundary of said media bed 4, said bottom seal boundary assisting in a prevention of an escape of contaminated Stream materials from said plenum.

A junction of floor 36 with said central support wall 5 is strengthened by an FRP bead reinforcement 36A FIG. 3B and a junction of said floor 35 with said lateral support wall 5 is strengthened by an FRP bead reinforcement 35A FIG. 3B, thus providing a further structural support to said base of said basket shaped media containment section

In the present embodiment, a pair of concentric, circular positioning elements, 7C, & 7D FIG. 2 comprising a pair of projections upwards from said floor 7B of said plenum are seen. A lateral framework base positioning element 7C FIG. 2 has an internal diameter slightly larger than that of an external diameter of said lateral support framework wall 3, and serves as a means for a positioning of said base end of that lateral framework and to provide a prevention of a lateral displacement of the base of said framework under a weight of said media in said media bed section 4, serving thus to assist in a prevention of an escape of contaminated Stream material from said plenum.

A central framework base positioning element 7D FIG. 2 has an external diameter that is slightly smaller than an internal diameter of said central most framework wall 5, and serves as a means for a positioning of said base end of that central framework and to provide a prevention of a lateral displacement of the base of that central framework in towards said outlet manifold 6 under a weight of said media located in said media bed section 4, serving thus to assist in a prevention of an escape of contaminated Stream materials from said plenum.

Said floor 7B FIG. 2 that forms a bottom seal section of said plenum, is appropriately anchored by one of several means to an appropriate foundation section, and at its periphery is joined to the side wall 7A of the plenum, which side wall forms a lateral boundary of the inlet manifold 2.

Above, said side wall 7a FIG. 2 is continuous with a top collar section 7EFG of said plenum's base section 7ABCDEFG. Said collar 7EFG FIG. 2 forms a constriction at the top of said side wall 7A section in which, a basilar projection 7E of said collar section 7EFG is seen as an integral, inward projection at 90.degree to said side wall 7A; a collar throat section 7F is integral with and projects vertically above said basilar projection; said collar throat 7F ends above and is integral with a laterally projecting element, a collar section top flange 7G that serves as a top plate of said base section 7ABCDEFG FIG. 2 of said plenum.

Said basilar projection of said plenum collar section provides: a horizontal projection that forms a top sealing element covering said intake manifold 200; a vertical portion, said collar throat 7F serves as a top guide/support for positioning said external framework 3. Said collar top flange 7G that projects laterally is perforated by a series of holes (not visible) designed to receive a set of bolts/nuts 10 that serve to attach said plenum's base section 7ABCDEFG to said removable split-cover top plate 9. It will be noted that a gasket 8 FIG. 2 is interposed between flange 7G and the removable split-cover top plate 9 section of the plenum and serves as a seal of a junction of said two parts.

A circular, central cutout—curved line—6C-6D FIG. 2 in removable split-cover top plate 9 FIG. 2 serves as a top guide/support for positioning said internal framework 5 and keeps said top of said framework properly aligned such that it forms a peripheral boundary of said exit manifold 6 within said base section 7ABCDEFG of said plenum.

Said collar throat 7F that serves as a top guide/support for positioning said external framework 3, acting in concert with a portion of split cover top plate 9 that serves as a top guide/support for positioning said internal framework, serves to define and create a top seal boundary of said media bed section, thus assisting in a prevention of an escape of contaminated Stream materials from said plenum.

Removable split-cover top plate section 9 FIG. 2, has two sets of holes, a peripheral set designed to receive said set of bolts/nuts 10, which said bolt and nut combinations serve to provide an affixation of said plenum base section to said top plate, and a second series surrounding said central cutout that receive a set of bolts/nuts 12, which said bolts/nuts serve to provide an affixation of said top plate to a horizontally aligned air outlet base flange 13A FIG. 2 of an air outlet section 13ABC FIG. 3A, which said outlet section is in a situation atop said split top cover plate. An outlet section base gasket 11 FIG. 2 serves as a seal for the junction between outlet section base flange 13A and split cover top plate 9.

At its central termination, said base flange 13A FIG. 2 then turns upwards at 90.degree as an air outlet side wall section 13B which then is continuous with a horizontally aligned air outlet top flange section 13C. Said flange section 13C FIG. 2 being pierced by a series of holes 14 to receive bolts—not shown—for attachment to an exit duct—not shown—that carries the remediated stream material into the environment.

A combination of said framework base positioning elements 7C, 7D FIG. 2 and said plenum top collar element sections and split cover top serve to position and support the top and base ends of said lateral and internal frameworks and serve in a manner holding said frameworks at a uniform distance from each other and said plenum wall throughout a full vertical length.

An internally projecting curvature A1 FIG. 2 of said side wall 7a of said plenum is seen. An internally projecting curvature B1 FIG. 2 of said lateral FRP support framework wall 3 is seen. A top cross section of said central most support framework wall 5 FIG. 2 is seen as a distance between arrow tips 6A and 6B FIG. 2.

Greater detail of a connection of and sealing of said base section 7ABCDEFG FIG. 2 to a top section 9-13C FIG. 2 of said plenum is presented in FIG. 3A.

FIG. 3A presents a diagrammatic lateral view showing a pair of top plate connecting flanges 9A, 9B of the removable top plate-sections 9. The bases of said split-cover top plate connecting flanges 9A, 9B are welded to said removable split-cover top plate sections 9 across their widths, and where said cover plate connecting flanges 9A,9B come together they are interconnected by a series of bolt and nut sets 9C—only one of which is visible. Also seen is a vertically situated gasket 9D that serves as a sealing element that seals a junction between said connecting flanges 9A,9B.

Said bolts 10 FIG. 3A serve to connect the two halves of said top plate 9 to said top flange section 7G of the base section collar 7EFG. Said gasket 11 is seen situated between said split-cover top plate 9 and collar section top flange 7G of base section collar 7EFG. The relative position of the above described elements to said walls of said base section of said plenum is best seen in FIG. 2 as a portion 7AEFG of said plenum 300.

An outlet section 13 ABC FIG. 3A has been included in order to spatially indicate the relationship of said outlet section to said removable split-cover top plate 9, an internal diameter of which top collar outlet section forms a continuation of said outlet manifold above the level of said removable split-cover top plate 9 as was seen prior in FIG. 2.

The great strength and design flexibility created by this invention allows of a creation of framework support walls for a use in a containment of a structurally integral, porous remediation media, said media commonly comprising a foam or a reticulated foam media. Said frameworks being of a variety of sizes for plenums ranging from a very small size to a very large commercial/industrial size radial flow unit.

Current production has created units ranging from said small units in which the support frameworks were 4 feet tall, having a central framework internal diameter of 6 inches with the external framework diameter being 3 feet; up to a very large unit, 20 feet tall with a central FRP framework diameter of 7 feet and an external FRP framework diameter of 11 feet. With respect to said larger construction mentioned above, it is a specific combination of FRP materials and said diamond shape basket weave wall configuration design elements created in this invention that allows of a creation of media containment systems suitable for service in large scale industrial and commercial purification projects, such as were not possible utilizing the prior art.
Optionally, in accord with the objective of creating frameworks having a structural strength allowing for their use in large commercial and municipal reactors, an additional structural support may be needed; said additional support being provided by a series of circumferential FRP framework reinforcement bands, which said bands may be applied in a fused conjoinment to the framework walls; said circumferential reinforcement bands being fused to said framework walls on at least an internally facing aspect of said lateral framework wall as well as at least on a laterally facing aspect of said central framework wall.
21 FIG. 2 presents a view showing a series of three circumferential outer framework wall reinforcement bands on an internally facing aspect of said lateral framework wall, said reinforcement bands being created in a fused conjoinment with the lateral FRP framework wall and serving to provide a reinforcement preventing a lateral displacement and deformation of the lateral framework under a pressure of said weight of said media, serving thus as a further means for assisting in a prevention of an escape of contaminated air from said plenum.
20 FIG. 2 presents a view showing a series of three circumferential outer framework wall reinforcement bands, only the cut ends of which are visible, said bands being on a laterally facing aspect of said central framework wall, said reinforcement bands being created in a fused conjoinment with the central FRP framework wall and serving to provide a reinforcement preventing a central displacement and deformation of the central framework under a pressure of said weight of said media.

What is claimed is:

1. A device comprising a media containment system within a vertically standing radial flow, remediation plenum, said media containment system providing for a containment of a structurally integral, porous remediation media that is used in a purification of one or more toxic contaminants selected from the group consisting of corrosive and non-corrosive vapors; said vapors being carried into said plenum in a contaminated air or water stream as said stream enters via an inlet section, and makes a sequential passage into and through an inlet plenum, a media containment section, an exit plenum and an outlet section of said plenum with said stream moving at a ambient or just above ambient air pressure;
said media containment system comprising in part, a pair of media support frameworks created in a basket weave diamond shape lattice pattern, said pair of frameworks each being of a differing diameter and being situated with a framework of a lesser diameter, a smaller, central framework standing within a framework of a greater diameter, a larger, lateral framework; and, said frameworks being in a coaxial alignment between themselves and relative to a side wall of said plenum;
said frameworks each having a configuration selected from the group consisting of cylindrical and multifaceted tubular structures;
said media containment section being bounded externally by an internal aspect of said lateral framework wall and centrally by a lateral aspect of said central framework wall;
means providing for a creation of a bottom seal boundary and a top seal boundary of said media containment section for assisting in a prevention of an escape of contaminated stream materials from said plenum;
a solid component of a wall element of each of said frameworks comprising a sandwich of a set of overlapping layers of a fiberglass reinforced plastic material that are fused together into a singular element; a series of through space openings comprising the remainder of said framework wall element of each of said pair of support frameworks;
means for providing an alignment and stabilization of said frameworks within said plenum, said alignment and stabilization serving to assist in a prevention of an escape of contaminated stream material from said plenum;
the design of said system allowing of a creation of a variety of sizes of media containment systems ranging from a small to a very large commercial size unit, and, allowing of a greater flow of said air stream through said plenum per unit of time, and, doing so with a less pressure drop from an inlet side to an outlet sided of said plenum, and using a less amount of energy than was possible in the prior art;
means for providing an additional support for a use in a large commercial size plenum holding a great weight of said media, said support serving to assist in a prevention of an escape of contaminated stream material from said plenum.

2. The media support wall of claim 1 in which said through space of said support wall framework comprises an approximately 68.percent portion of a total surface area of said support framework wall area.

3. The structurally integral, porous remediation media of claim 1 comprising a foam media.

4. The structurally integral, porous remediation media of claim 1 comprising a reticulated foam media.

5. The media support frameworks of claim 1 comprising a cylindrical configuration.

6. The media support frameworks of claim 1 comprising a multifaceted configuration.

7. The means of claim 1 for assisting in said prevention of said escape of contaminated stream material from said plenum by providing said alignment and stabilization of said frameworks within said plenum comprising:
below, a pair of framework positioning elements located in a floor of said plenum; and
above, a portion of a top plate of said plenum for said central framework, and a collar throat section of said plenum for said lateral framework.

8. The means of claim 1 for assisting in said prevention of said escape of contaminated stream material from said plenum by providing said alignment and stabilization of said frameworks within said plenum comprising:
below: an integral floor section of each of said lateral and said central frameworks, said integral floor sections being created in a reinforced fusion with said external and internal framework walls, said integral floor sections being separate from a floor of said plenum as well as being separate from each other;
said alignment and stabilization means further comprising above: a portion of a top plate of said plenum for a top stabilization of said internal framework, and a collar throat section of said plenum for a top stabilization of said external framework;
further, said integral flooring sections of said alignment and stabilization means creating a basket shape media bed, said basket shape media bed allowing of a removal of said frameworks as a unit from said plenum for purposes of a replacement of said media.

9. The vertically standing air stream remediation plenum of claim 1 further comprising a base section, a lateral wall section, a top collar section, and a removable split cover top plate section, said outlet section being in an affixation atop said split cover top plate;
and within which said plenum are situated said pair of media support wall frameworks forming said media containment section, which said media containment section allows of a uniform thickness of said remediation media in a radial direction between said inlet manifold and said outlet manifold of said plenum;
said through spaces of said framework walls allowing said radial flow of said contaminated stream from said inlet manifold, through said lateral support framework wall, into and through said remediation media, then through said central most support framework wall, and finally into said outlet manifold for a discharge from said plenum through said air outlet section;

10. The optional means of claim 1 serving to assist in a prevention of an escape of contaminated stream material from said plenum by a provision of said additional framework wall support for said use in large commercial size plenums holding said great weight of said media comprising a fusion of a series of circumferential FRP framework reinforcement bands to said lateral framework as well as to said central framework.

11. A process for a purification of a contaminated air stream:
a. by moving said contaminated stream, at a ambient or slightly above ambient air pressure, through an air intake in a side wall of, and thus into, an inlet manifold of a vertically standing, radial flow air remediation plenum;
b. passing said stream next in a radial direction through a series of through spaces in a lateral support framework wall, said lateral framework wall comprising one of a pair of concentrically arranged media support frameworks of differing diameters, a framework of a lesser diameter, a smaller, central framework standing within a framework of a greater diameter, a larger, lateral framework; and, said frameworks being held in a coaxial alignment between themselves and relative to said side wall of said plenum by a series of top section, base section, and side wall supports; said frameworks each having a basket weave diamond shaped lattice pattern wall, said lattice of said walls comprising a Fiberglass Reinforced Plastic material; a total through space of said frameworks comprising an approximately 68.percent portion of a total surface area of said framework walls;
c. following said passage through said lateral framework wall said stream passes into a media containment section of said plenum, which said media containment section contains a media, said media comprising a structurally integral, porous remediation media;
d. following a contact of said stream with said media contained within said media bed, said stream next passes though a series of through spaces in said central media support framework wall;
e. after said passage through said central media support framework wall, said air stream passes into an outlet manifold section;
f. and thence exits from said plenum through said air outlet section as a purified stream.

12. The structurally integral, porous remediation media of claim 11 comprising a foam media.

13. The structurally integral, porous remediation media of claim 11 comprising a reticulated foam media.
